(19) United States
(12) Patent Application Publication
(10) Pub. No.: US 2013/0262785 A1
(43) Pub. Date: Oct. 3, 2013

(54) INFORMATION PROCESSING APPARATUS AND SYNCHRONOUS PROCESS EXECUTION MANAGEMENT METHOD

(71) Applicants: Norio ISHII, Yamato (JP); Yoshihiro Nishida, Kawasaki (JP)

(72) Inventors: Norio ISHII, Yamato (JP); Yoshihiro Nishida, Kawasaki (JP)

(73) Assignee: FUJITSU LIMITED, Kawasaki-shi (JP)

(21) Appl. No.: 13/769,404

(22) Filed: Feb. 18, 2013

(30) Foreign Application Priority Data
Mar. 30, 2012 (JP) 2012-080800

(51) Int. Cl. G06F 3/06

(52) U.S. Cl. CPC G06F 3/067
USPC 711/147

(57) ABSTRACT

An information processing apparatus having a storage apparatus shared by a plurality of processors, includes a decision unit that decides, when there is a process to be executed by the plurality of processors synchronously, a group of processors that execute the process from among the plurality of the processors; a control unit that stores a total number of the group of processors in the storage apparatus and make the group of processors execute the process; a counting unit that counts a number of processor that executed the process in the group of processors; a comparison unit that compares the total number of the processors and a counted number of the processors; and a notification unit that sends a notification that all the processors included in the group of the processors executed the process, based on a comparison result.

### CROSS-REFERENCE TO RELATED APPLICATION

This application is based upon and claims the benefit of priority of the prior Japanese Patent Application No. 2012-080800, filed on Mar. 30, 2012, the entire contents of which are incorporated herein by reference.

### FIELD

The present invention relates to an information processing apparatus including a plurality of processors that are capable of accessing the same storage apparatus.

### BACKGROUND

In a processor such as a Central Processing Unit (CPU) that is capable of executing a program, a process (hereinafter, a “synchronous process”) may be synchronized with other processors and may be executed successively. In the synchronous process, all the processors that execute the synchronous process have to execute the next synchronous process after all the processors finish the synchronous process. The judgment of the timing (synchronization point) to shift to the next synchronous process may be configured to by performed by, for example, storing a numerical value for synchronization judgment on a storage apparatus that is accessible by each processor, and making the processor that finished the synchronous process update the numerical value for the synchronization judgment.

The update of the numerical value is performed by incrementing or decrementing the value for synchronization judgment.

When incrementing the numerical value, the storage apparatus stores, usually, other than the numerical value to be the target of the update, a numerical value representing the total number of processors that execute the synchronous process. Each processor is able to judge whether or not all the processors that execute the synchronous process finished the synchronous process, by comparing the two numerical values. For this reason, the processor that finishes the synchronous process before all other processors finish the synchronous process is able to wait until all other processors finish the synchronous process. Normally, the initial value of the numerical value to be the target of update is 0, and the numerical value representing the total number is its total number. Hereinafter, for the sake of convenience, the numerical value to be the target of update is described as the “count value”, and the numerical value representing the total number is described as the “number of waiting target CPUs”, respectively.

On the other hand, when decrementing the numerical value, the storage apparatus stores, usually, as the initial value of the count value, the number of waiting target CPUs. When the number of waiting target CPUs is the initial value of the count value, the count value becomes 0 with all the processors that execute the synchronous process finishing the synchronous process. Accordingly, each processor is able to judge whether or not all the processors that execute the synchronous process finished the synchronous process, by checking whether or not the count value is 0.

A plurality of synchronous process are usually performed successively. Conventionally, the total number of the processors made to execute the synchronous process has been fixed (constant). However, in the synchronous processes to be executed by the processors, there are some that are not necessarily able to end the synchronous process appropriately. There are some cases in which the processor is made to execute synchronous processes in a relationship to be affected strongly by an execution result of another synchronous process successively. For example, there are some cases in which, when it is impossible to end another synchronous process appropriately, the synchronous process that is not expected to be ended appropriately is executed after another synchronous process.

When two synchronous processes in a relationship to be significantly affected by the execution result are executed successively by the respective processors, whether or not to end a certain synchronous process appropriately often depends on the processor. When a processor that is not expected to end the synchronous process appropriately is made to execute the synchronous process, the processing time of the processor may be extremely longer than other processor. When the processing time becomes extremely longer in such a way, it also significantly affects the total processing time required for finishing all of the synchronous processes that should be executed. According to these, depending on the detail of the synchronous process to be executed by the respective processor, it also seems necessary to consider the execution state of the respective synchronous processes in the respective processors.

This is explained more specifically below.

In a CPU, a dedicated program (hereinafter, referred to as the “test program”) is executed, to perform a test to examine the microarchitecture, that is, the internal structure design of the CPU. In a processing system including a plurality of CPUs (processors), normally, as the test program, a test program including a subprogram to perform the test, and another subprogram to launch the subprogram is used. Here, hereinafter, the subprogram to perform the test is referred to as the “test unit”, and the subprogram to launch the test unit is referred to as the “initial processing unit”, respectively.

For example, the test program performs examination of the microarchitecture of each CPU in stand-alone mode. The examination of the microarchitecture may be performed by dividing the CPU into a plurality of examination targets and for each of the examination targets. In this case, the examination of each of the examination targets is performed as a separate synchronous process respectively.

The examination dividing the CPU into a plurality of examination targets may be based on a prerequisite that another examination target operates appropriately. For example, when an examination of whether or not the access to a memory mounted on a CPU (normally a cache) is performed appropriately and an examination of the calculation function using data stored in the memory are performed separately, the examination of the calculation function is performed based on a prerequisite that the access to the memory is performed appropriately. When the access to the memory by the CPU is not performed appropriately, it becomes practically impossible to perform the examination of the calculation function which is based on a prerequisite of an appropriate access to the memory. There is no need to perform an impossible examination. The examination result of each examination target at each CPU does not affect other CPUs. For this reason, it also seems necessary to consider the trouble occurring from the execution of the examination of the calculation function.

### PRIOR ARTS DOCUMENTS

### Patent Document

[Patent document 1] Japanese Laid-open Patent Publication No. 7-152694
[Patent document 2] Japanese Laid-open Patent Publication No. 11-312148
[Patent document 3] Japanese Laid-open Patent Publication No. 03-113564

### SUMMARY

According to an aspect of the embodiments, an information processing apparatus having a storage apparatus shared by a plurality of processors, the information processing apparatus includes a decision unit configured to decide, when there is a process to be executed by the plurality of processors synchronously, a group of processors that execute the process from among the plurality of the processing processors; a control unit configured to store a total number of the decided group of processors in the storage apparatus and make the group of processors execute the process; a counting unit configured to count a number of processor that executed the process among the processors included in the group of processors; a comparison unit configured to compare the total number of the processors and a counted number of the processors; and a notification unit configured to send a notification that all the processors included in the group of the processors executed the process, based on a comparison result by the comparison unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of an information processing apparatus according to the present embodiment;

FIG. 2 is a diagram representing a function configuration example of a program according to the present embodiment;

FIG. 3 is a diagram illustrating a data example stored in a synchronization management area secured on a memory by a program according to the present embodiment;

FIG. 4 is a diagram illustrating a configuration example of a CPU;

FIG. 5 is a flowchart representing a process executed by each CPU by the control of a program according to the present embodiment;

FIG. 6 is a flowchart of a first test process;

FIG. 7 is a flowchart of a second test process; and

FIG. 8 is a flowchart of a third test process.

### DESCRIPTION OF EMBODIMENTS

Hereinafter, an embodiment of the present invention is explained in detail with reference to drawings.

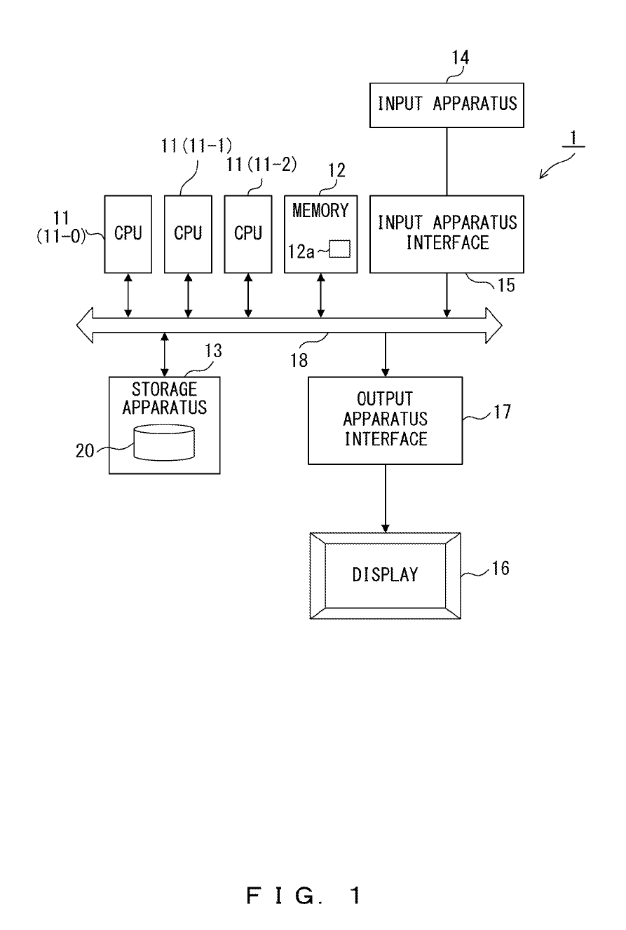

FIG. 1 is a diagram illustrating a configuration example of an information processing apparatus according to the present embodiment. As illustrated in FIG. 1, an information processing apparatus 1 includes a total of three CPUs 11 (CPU 11-0 through CPU 11-2), a memory (a memory module for example) 12, a storage apparatus 13, an input apparatus 14, an input apparatus interface (I/F) 15, a display 16, and an output apparatus interface (I/F) 17. The CPUs 11-0 through 11-2, the memory 12, the storage apparatus 13, the input apparatus 14, the input apparatus interface (I/F) 15, the display 16, and the output apparatus interface (I/F) 17 are connected to each other via a bus 18. While the number of the CPUs 11 is 3, the number of the CPUs 11 may be any as long as it is 2 or larger.

The storage apparatus 13 is a non-volatile storage apparatus such as a hard disk apparatus or a semiconductor storage apparatus and the like, and a program 20 according to the present embodiment is stored in the storage apparatus 13. In the according embodiment, the program 20 is assumed as for a test for examining (the microarchitecture of) each of the CPUs 11. Accordingly, hereinafter, the program 20 is described as a “test program 20”.

The test program 20 divides the CPU 11 into a plurality of examination targets, and executes a test to examine the examination target, for each of the examination targets. The process for each test is a synchronous process which causes each of the CPUs 11 to synchronize and execute. In this embodiment, for descriptive purposes, it is assumed that three synchronous processes for the test to examine the examination target are executed successively.

The memory 12 is a storage apparatus that is accessible from all the CPUs 11, in which an area 12a for each of the CPUs 11 to execute the test program 20 is secured. The area 12a is used for synchronizing synchronous processes by each of the CPUs 11. Hereinafter, the area 12a is referred to as a “synchronization management area”.

The test program 20 becomes the execution target for all the CPUs 11 (11-0 through 11-2). The test program 20 includes a test unit 22 being a subprogram for actually executing the test, an initial processing unit 21 being another subprogram for launching the test unit 22, and an end processing unit 23 being a subprogram to end the test program 20. The information processing apparatus 1 according to the present embodiment is realized by making each of the CPUs 11 execute the test program 20.

In the information processing apparatus 1 which has a configuration represented in FIG. 1, the initial processing unit 21 of the test program 20 makes one of the three CPUs 11 realize a test control function to control the execution of the test in other CPUs 11. The initial processing unit 21 that is capable of realizing the test control function makes the CPU (own CPU) 11 in which the initial processing unit 21 is executed launch the test program 22, and also makes the other CPUs 11 launch the test unit 22. As a result, the initial processing unit 21 that realizes the test control function makes the respective CPUs 11 start the test in parallel. Hereinafter, the CPU 11 in which the test control function is realized is described as a “master CPU 11” for descriptive purposes.

One of the respective CPUs 11 reads the test program 20 stored in the storage apparatus 13 onto the memory 12 according to an instruction from the tester via the bus 18 and the input apparatus interface 15 for example, and launches the test program 20. At this time, the CPU 11 that launched the test program 20 operates as the master CPU 11.

As illustrated in FIG. 1, numerals 11-0 through 11-2 are assigned to the CPUs 11. In those numerals, the number following the hyphen represents the ID number assigned to the corresponding CPU 11. The one that becomes the master CPU 11 is the CPU 11 whose ID number is the smallest, for example. The master CPU 11 makes the other CPUs 11 launch the test program 20 by executing the initial processing unit 21 of the test program 20.

As described above, the test program 20 divides the CPU 11 into a plurality of examination targets, and realizes the test for examining the examination targets, for each of the examination targets. The process included in the test for examining the examination target is realized by the execution of the test unit 22.

The end processing unit 23 is a subprogram to which the control is passed from the test unit 22. The test program 20 is ended by the end processing unit 23. The end processing unit 23 that the master CPU 11 executes waits for the end of tests by the other CPUs 11, and realizes the function to output the test result executed by the respective CPUs 11 including the own CPU 11. By the function to output the test result executed by the respective CPUs 11, the tester is able to check the test result of the respective CPUs 11. The output of the test result is performed using the display 16 in the configuration represented in FIG. 1.

The test result of the other CPUs 11 may be collected by communication via the bus 18 or by obtaining the test result via the memory 12. The test result of each of the CPUs 11 is stored in, for example, the memory 12.

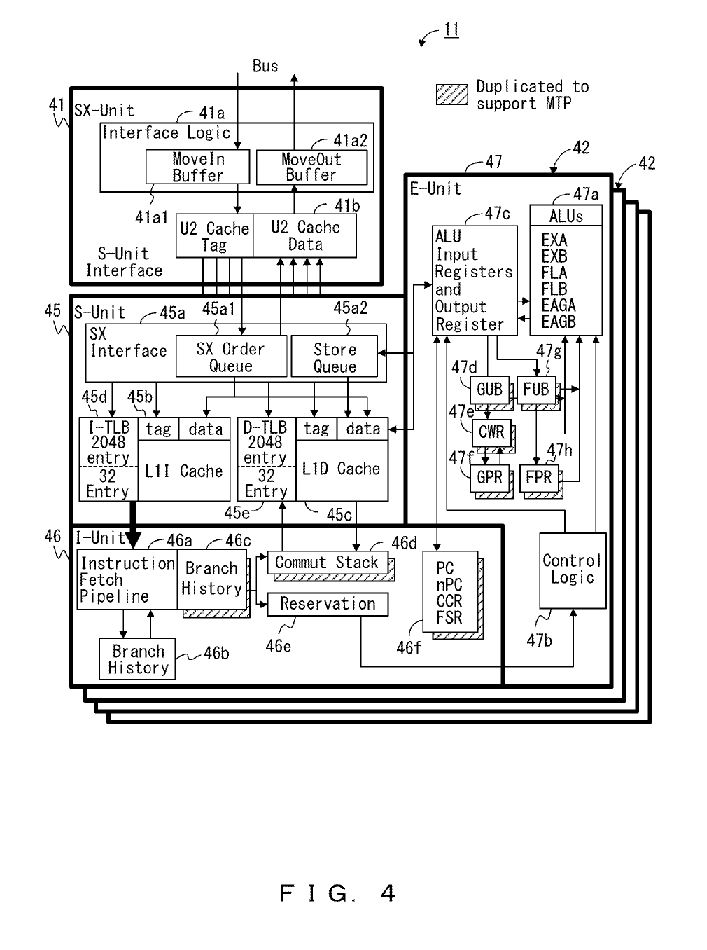

FIG. 4 is a diagram illustrating a configuration example of a CPU. Here, referring to FIG. 4, a configuration example of the CPU 11 which is the target to execute the test program 20, and the examination target which is the target of the test in the CPU 11 of the configuration example.

The CPU 11 represented in FIG. 4 supports Multi Threaded Processing (MTP), and includes one Secondary Cache and External Access Unit (SX unit) 41 and four CPU cores 42. Each of the CPU cores 42 includes a Storage Unit (S unit) 45, an Instruction Control Unit (I unit) 46, and an Execution Unit (E unit) 47.

The SX unit 41 includes a level 2 unified cache (described as “U2 Cache” in FIG. 4) 41b, and performs data input/output with the S unit 45 of each of the CPU cores 42. The SX unit 41 includes an interface logic 41a for performing data transmission/reception via the bus 18. The interface logic 41a includes a move-in buffer 41a1 that stores data received from the bus 18 and a move-out buffer 41a2 that stores data to be transmitted to the buffer 18. The data received from the bus 18 is data from the memory 12, and data transmitted to the bus 18 is data to be stored in the memory 12.

The S unit 45 of each of the CPU cores 42 performs supply and reception of all data for load and store instructions. For that purpose, the S unit 45 includes an interface 45a for the SX unit 41 (described as “SX Interface” in FIG. 4), a level 1 cache 45b for instruction (described as “L1I Cache”), a level 1 cache 45c for data (described as “L1D Cache” in FIG. 4), a Translation Look-aside Buffer (TLB) 45d for instruction (described as “I-TLB” in FIG. 4), and a TLB 45e for data (described as “D-TLB” in FIG. 4). The interface 45a includes a buffer 45a1 used for storing data (including an instruction) input from the SX unit 41 (described as “SX Order Queue” in FIG. 4), and a buffer 45a2 used for storing data from the E unit 47 (described as “Store Queue” in FIG. 4).

The instruction and data from the SX unit 41 are stored in the buffer 45a1 or the buffer 45a2 of interface 45a, and further stored in the cache 45b or the cache 45c. At this time, the address of the instruction or data stored in the cache 45b or the cache 45c is a logic address (virtual address).

The TLB 45d converts the logic address of the instruction to a corresponding physical address (real address), and stores the correspondence relationship of the logic address and the physical address. The logic address is handled as a tag, and the instruction is stored in an entry identified by the tag in the cache 45b. The TLB 45d includes a table in which a plurality of entries being capable of storing, for example, the tag (logic address (for example a virtual page number)), the physical address (for example a physical page number), and a state flag is secured. Among the entries of the table, 32 entries are Full Associative in which a different logic address may be stored for each entry, and 2048 entries are two-way Set Associative in which the same logic address may be stored in two entries. The same applies to the TLB 45e.

The instruction goes through a pipeline process. In the pipeline process, the instruction is thrown in speculatively. The buffer 45a2 is for separating the latency of the store instruction from the pipeline process, and enables the continuation of the pipeline process while the store instruction waits for data.

The I unit 46 includes an instruction fetch pipeline 46a, a branch history 46b, an instruction buffer 46c, a commit stack entry 46d, reservation station group 46e, and a register group 46f. In order to support MTP, the instruction buffer 46c, the commit stack entry 46d and the register group 46f are respectively duplexed.

The instruction fetch pipeline 46a performs the address generation of the instruction to be fetched, access to the cache 45b, writing of the instruction into the instruction buffer 46c, and the like. The branch history 46b is a table for predicting the branching destination and branching direction of the instruction. The instruction fetch pipeline 46a fetches the instruction referring to the branch history 46b, and writes it into the instruction buffer 46c. The instruction buffer 46c is a buffer for keeping the instruction fetched in that way.

The commit stack entry 46d is a buffer for keeping information of the instruction being executed. The respective reservation stations constituting the reservation station group 46e are a buffer for keeping the associated type of instruction while it becomes executable. The instruction that has become executable is read from the corresponding reservation station and output to the E unit 47.

The register group 46f is various registers for program visualization for instruction execution control. PC, nPC, CCR, and FSR described in FIG. 4 represent different register types, respectively. The PC is an abbreviation “Program Counter”. In the same manner, nPC is an abbreviation of “next Program Counter”, CCR is “Condition Code Register”, and FSR is “Floating-Point State Register”.

The PC keeps the address of the instruction to be thrown in next. The nPC keeps the address to be stored in the PC next. The CCR keeps a condition code having a plurality of flags for example. The FSR keeps the execution mode and state information of an Arithmetic and Logic Unit (ALU) to process floating-point data in the E unit 47.

The E unit 47 includes an ALU group 47a for processing the instruction. As ALUs constituting the ALU group 47a, there are two integer execution pipelines (described as “EXA”, “EXB” in FIG. 4), two floating point execution pipelines (described as “FLA”, “FLB” in FIG. 4), two virtual address adder (described as “EAGA”, “EAGB” in FIG. 4). The ALU whose execution mode is stored in FSR of the register group 46f that the I unit 46 has is a floating point execution pipeline.

The control logic 47b accesses the reservation station group 46 of the I unit 46, reads an instruction that has becomes executable (ready for throwing in) from a corresponding reservation station, and supplies it to the corresponding ALU in the ALU group 47a. Data required for executing the instruction of the ALU group 47a is obtained from the buffer 45a2, the cache 45c, or the register group 46f via the register group 47c. Data obtained by the execution of the instruction of the ALU group 47a is stored in either of the registers, the buffer 45a2, the cache 45c, or the register group 46f via the register group 47c.

The E unit 47 includes, other than the constituent elements mentioned above, a GPR Update Buffer (GUB) 47d, a Current Window Register (CWR) 47e, a General Purpose register (GPR) 47f, an FPR Update Buffer (FUB) 47g and an Floating Point Register (FPR) 47h. These are duplexed to support MTP. While it is not clear in FIG. 4, a plurality of units of these GUB 47d, GPR 47f, FUB 47g and FPR 47h exist respectively.

The GPR 47f is a general-purpose register used for keeping integer data. The CWR 47e is a register used for copying the GPR 47f. The GUB 47d is a renaming register file for the GPR 47f. The FPR 47h is a register used for keeping floating-point data. The FUB 47g is a renaming register file for the FPR 47h.

In the CPU 11 configured as described above, when executing the test divided into three, the examination target of each test could be divided into three of the SX unit 41 and the S unit 45 of each CPU core 42, the I unit 46 of each CPU core 42, and the E unit 47 of each CPU core 42, for example. The respective tests may be executed in described order of the tests divided into three, for example. Hereinafter, for descriptive purposes, the test targeted at the SX unit 41 and the S unit 45 of each CPU core 42 is described as the “first test”, the test targeted at the I unit 46 of each CPU core 42 is described as the “second test”, and the test targeted at the E unit 47 of each CPU core 42 is described as the “third test”, respectively.

When the constituent elements of the CPU 11 are divided into three examination targets, the second test targeted at the I unit 46 of each CPU core 42 is to be based on a prerequisite that the instruction and data are appropriately stored in the caches 45b and 45c of the SX unit 45, respectively. For this reason, when an inappropriate portion is found in the first test, or the first test could not executed appropriately (for example, the execution of the process for the test hung up), it follows that the second test does not need to be performed. Accordingly, in the present embodiment, each CPU 11 is made to autonomously select and execute the test that should be executed. By making each CPU 11 perform the autonomous selection of the test to be performed, it becomes possible to avoid making the CPU 11 execute a test that seems to have a possibility of a significant negative influence such as to delay the completion of the whole test to a large extent. Accordingly, it becomes possible to make each CPU 11 execute each test stably as a whole.

Here, for descriptive purposes, it is assumed that the second test is executed according to the result of the first test, and the third test is performed according to the result of each of the first test and the second test. Specifically, the CPU 11 in which no problem is found in the first test successively executes the second test, and the CPU in which a problem is found in the first test executes the third test next, without executing the second test. The CPU 11 in which a problem is found in the second test does not execute the third test.

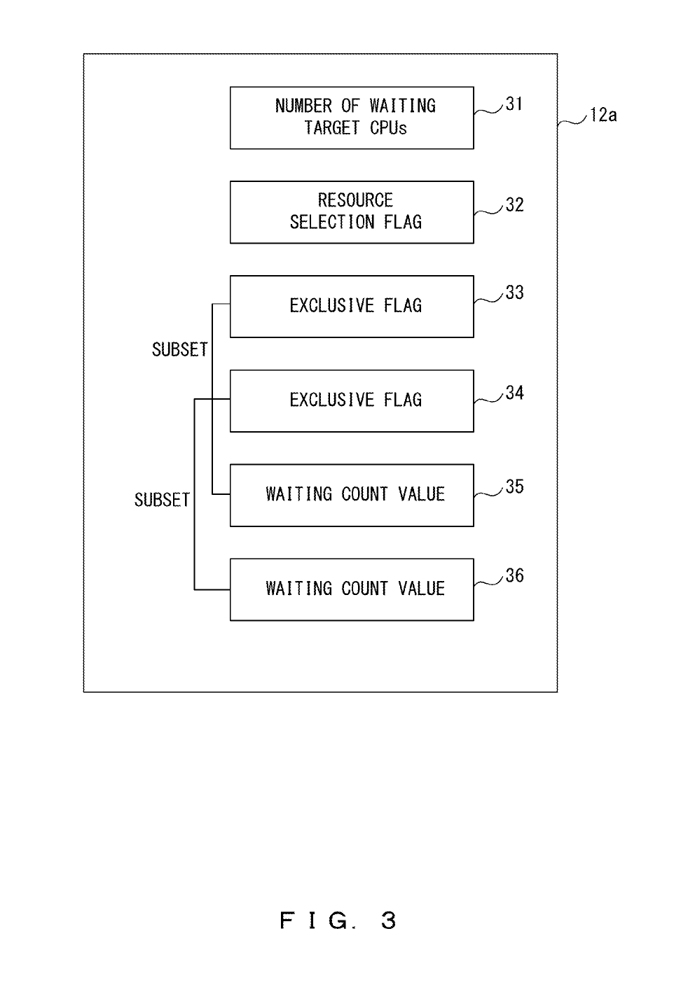

The first through third tests are respectively executed in different processes. The respective CPUs 11 are made to execute the respective processes synchronously. Each of the CPUs 11 that execute the synchronized processes has to recognize that all the other CPUs 11 that execute the processes finished the process. The selection of the test performed autonomously by each CPU 11 means that, the number of the CPUs 11 to be the synchronization target increases and decreases in accordance with the process (test). Accordingly, in this embodiment, data described below is stored in the synchronization management area 12a secured on the memory 12. It is specifically explained referring to FIG. 3.

As illustrated in FIG. 3, in the synchronization management area 12a, six data storage areas 31 through 36 are secured. Here, each of the data storage areas is described as a “register” below.

The register 31 through the register 36 store, as data, the number of waiting target CPUs, a resource selection flag, an exclusive flag, an exclusive flag, a waiting count value, a waiting count value, respectively. The register 33 and the register 35, and the register 34 and the register 36 respectively form a subset.

The number of waiting target CPUs stored in the register 31 represents the total number of CPUs 11 that execute the process for the test. The resource selection flag stored in the register 32 represents the valid subset in the two subsets. Here, it is assumed that the subset of the register 33 and the register 35 is valid when the value of the resource selection flag is 0, and when the value is 1, the subset of the register 34 and the register 36 is valid.

The exclusive flag stored respectively in the register 33 and the register 34 is data for exclusively updating the corresponding flag 35, or the waiting count value stored in the register 36. The exclusive flag makes it possible for only one CPU 11 to update the waiting count value of the register 33 or 34 of the valid subset.

Here, it is assumed that the value of the exclusive flag being 0 represents the non-exclusive state, that is, a state in which any CPU 11 may shift to the exclusive state, and the value being 1 represents the exclusive state, that is, a state in which only the CPU 11 shifted to the exclusive state is able to update the waiting count value. Hereinafter, the shifting to the exclusive state by the update of the exclusive flag is also expressed as “exclusion acquisition”. In this embodiment, in the register 33 or the register 34 of the invalid, not valid subset, for example, an exclusive flag with the value 0 is stored.

In this embodiment, the CPU 11 that finished the execution of the process for the test is made to execute the exclusion acquisition of the currently valid subset, and to increment the waiting count value of the subset. The initial value of the waiting count value is 0. Accordingly, each CPU 11 is able to check whether or not all the CPUs 11 that should execute the currently targeted test have finished the test, by whether or not the waiting count value of the currently valid subset is identical with the number of waiting target CPUs in the register 31.

As described above, in this embodiment, each CPU 11 is made to autonomously select the test that should be executed. By the autonomous selection of the test that should be executed, each CPU 11 is made to update the number of waiting target CPUs in the register 31, according to the selection result. By the number of waiting target CPUs, the CPU that executes the immediately precedent test and does not execute the next test decrements the number of waiting target CPUs. Meanwhile, the CPU 11 that does not execute the immediately precedent test and executes the next test increments the number of waiting target CPUs.

Each CPU 11 updates the number of waiting target CPUs according to the situation. For that reason, each CPU 11 that becomes the execution target of the test (synchronized process) is able to recognize the end of the test of all the CPUs that execute the test, regardless of whether or not the test is executed, and regardless of the increase/decrease of the other CPUs that execute the test.

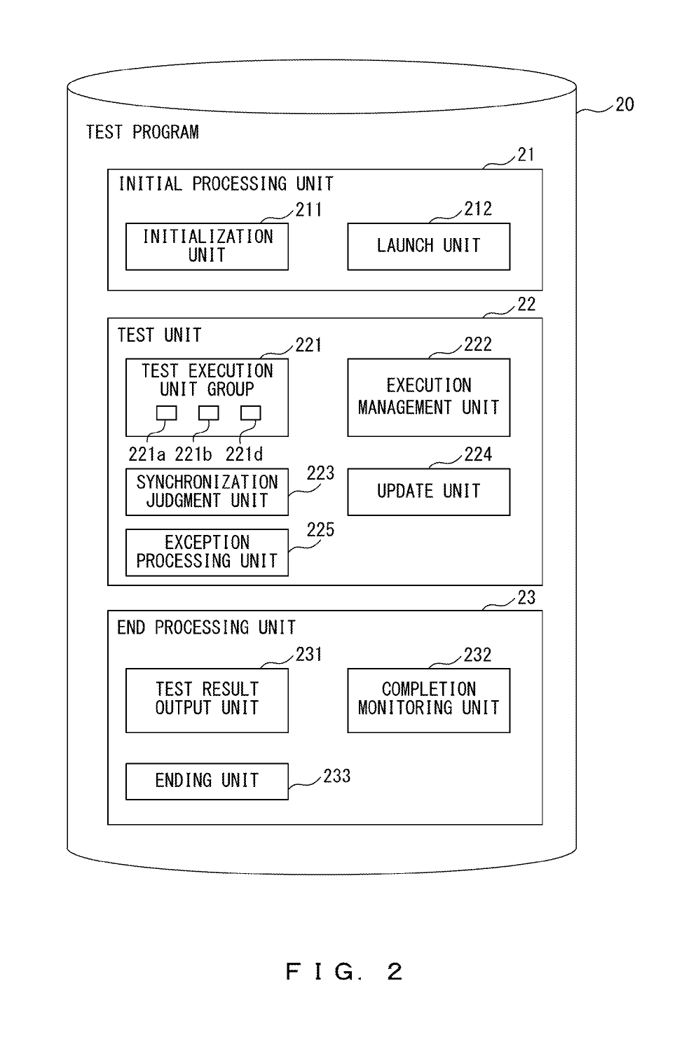

In order to enable the synchronized execution of the test by the respective CPUs 11 using the synchronization management area 12a, in the present embodiment, the test program 20 has the function configuration described below. It is described specifically referring to FIG. 2.

As illustrated in FIG. 2, the initial processing unit 21 includes, as the function configuration (a subprogram for example), an initialization unit 211 and a launch unit 212.

The initialization unit 211 is a function to store data that should be stored first in each of the registers 31 through 36 in the synchronization management area 12a, and becomes active only in the master CPU 11. The launch unit 212 is a function to launch the test unit 22, and is used in each CPU 11. In the launch unit 212 that is executed by the master CPU 11, the function to make other CPUS 11 launch the test program 20 becomes active.

As illustrated in FIG. 2, the test unit 22 includes, as the functional configuration (a subprogram for example), a test execution unit group 221, an execution management unit 222, a synchronization judgment unit 223, an update unit 224, and an exception processing unit 225.

The test execution unit group 221 is a function group for executing the first test through the third test. The test execution unit group 221 includes a first test execution unit 221a for executing the first test, a second test execution unit 221b for executing the second test, and a third test execution unit 221c for executing the third test.

The execution management unit 222 is a function to make the first through third test execution units 221a-221c constituting the test execution unit group 221 execute the respective tests sequentially in an order determined in advance. The autonomous selection of the test to be executed is realized by the execution management unit 222.

The synchronization judgment unit 223 is a function to compare the value of the waiting counter of the valid subset and the number of waiting target CPUs, and to judge whether or not all the CPUs that should execute the current target test have finished the test. CPUs 11 other than the CPU 11 that is the last to finish the test among the CPUs 11 that should execute the test perform waiting for all the CPUS 11 that should execute the test to finish the test.

The update unit 224 is a function to realize the update of data stored in the synchronization management area 12a. All the CPUs 11 that execute the test program 20 are able to update data stored respectively in all the registers 31 through 36 presented in FIG. 3.

The exception processing unit 225 is a function to handle the trouble that occurs during the execution of the test by one of the first through third test execution units 221a-221c, for example, a hang-up. The exception processing unit 225 enables each CPU 11 to handle the trouble that occurs during the execution of the test.

As illustrated in FIG. 2, the end processing unit 23 includes, as the functional configuration (a subprogram for example), a test result output unit 231, a completion monitoring unit 232, and an ending unit 233.

The test result output unit 231 is a function to output the result of each test by each CPU 11. The display of the result of each test by each CPU 11 on the display 16 presented in FIG. 1 is realized by the test result output unit 231. Accordingly, the test result output unit 231 becomes active only in the master CPU 11.

The output of the result of each test by each CPU 11 has to be performed after all the CPUs 11 finish the last test. The completion monitoring unit 232 is a function to monitor all the CPU 11 finish the last test. Accordingly, in the same manner as the test result output unit 231, it becomes active only in the master CPU 11.

The ending unit 233 is a function to end the test program 20. It is active in all the CPUs 11. In the CPU 11 other than the master CPU 11, when the control is passed from the test unit 22 to the end processing unit 23, the process by the ending unit 233 is performed immediately.

In this embodiment, the autonomous selection of the test by each CPU 11 and response to the selection result are enabled by adding functions respectively to the initialization unit 211 of the initial processing unit 21, and the execution management unit 222 and the update unit 224 of the test unit 222. The functional configuration of the initial processing unit 21, the test unit 22, and the end processing unit 23 illustrated in FIG. 2 is an example, and the functional configuration is not a limitation. The subprograms constituting the test program 20 are not limited to three units, the initial processing unit 21, the test unit 22, and the end processing unit 23.

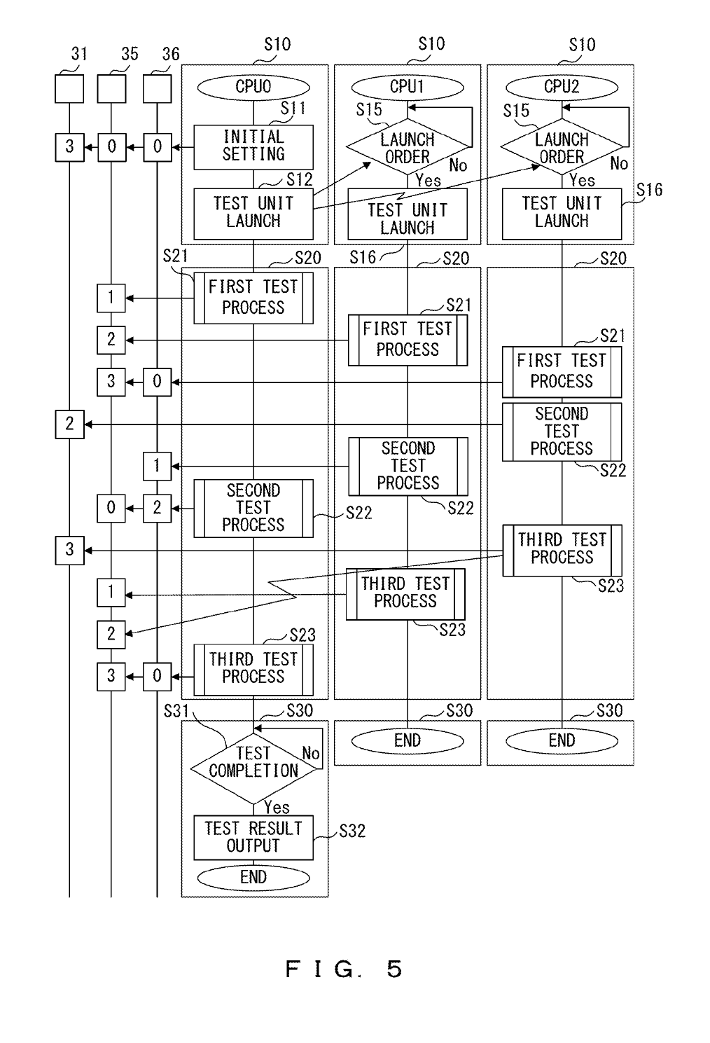

FIG. 5 is a flowchart representing the process executed by each CPU according to the control of the test program. The process presented in FIG. 5 is realized by the CPU 11, which becomes the master CPU 11 (11-0) among the respective CPUs 11, launching the test program 20. In FIG. 5, the “CPU0” represents the mater CPU 11, and “CPU1” “CPU2” respectively represent CPUs 11 other than the mater CPU 11. Hereinafter, the CPUs 11 other than the mater CPU 11 are described as “other CPUs”. Next, referring to FIG. 5, the process executed by each CPU 11 according to the control of the test program 20 is explained specifically.

When each CPU 11 has the configuration presented in FIG. 4, the process presented in FIG. 5 is realized by one of the four CPU cores 42 executing the instruction of the test program 20 supplied sequentially via the SX unit 41. In FIG. 5, in order to facilitate understanding, the sequence in which the number of waiting target CPUs and the two waiting count values stored as data in the registers 31, 35, 36 respectively are updated is also presented. The numbers “0” through “3” in FIG. 5 represents the value of corresponding data.

In FIG. 5, S10, S20, and S30 are processes realized by the initial processing unit 21, the test unit 22, and the end processing unit 23, respectively. As illustrated in FIG. 5, in the test program 20, the process is passed in order of the initial processing unit 21->the test unit 22->the end processing unit 23.

The master CPU 11 loads the test program 20 on the storage apparatus 13 onto the memory 12 according to an instruction of the tester input from the input apparatus 14 via the input apparatus interface 15 and the bus 18, and launches the test program 20. According to the launch, the master CPU 11 executes S10 by the initial processing unit 21. The following process is executed in S10.

First, the mater CPU 11 secures the synchronization management area 12a on the memory 12, and performs initial setting to respectively store data to be the initial value in the respective registers 31 through 36 of the area 12a (S11). According to the initial setting, “3” as the number of waiting target CPUs is stores in the register 31, “0” as the resource selection flag is stored in the register 32, “0” as the exclusive flag is stored in the respective registers 33 and 34, and “0” as the waiting count value is stored in the respective registers 35 and 36.

Next, the master CPU 11 launches the test unit 22, and also instructs the other CPUs 11 to launch the test program 20 (S12). According to the launch of the test unit 22, the control is passed from the initial processing unit 21 to the test unit 22. Accordingly, the series of the processes in S10 end here, and the execution of S20 starts.

The above-described S11 is realized by the initialization unit 211 presented in FIG. 2. S12 is realized by the launch unit 212.

In S10 executed in the other CPUs 11, the following process is executed.

The other CPUs 11 are in the standby state to wait for the reception of a launch instruction of the test program 20 from the master CPU 11 (S15). Upon receiving the launch instruction, the other CPUs 11 that received the launch instruction launch the test unit 22 (S16). According to the launch of the test unit 22, the series of processes in S10 in the other CPUs 11 end here, and S20 is executed by the launched test unit 22.

In S20, each CPU 11 sequentially execute the first test process of S21, the second test process of S22, and the third test process of S23. According to the finish of the third test process of S23, the control is passed from the test unit 22 to the end processing unit 23, and each CPU 11 moves from S20 to S30.

The other CPUs 11 end the test program 20 according to the moving to S30. The ending is realized by the ending unit 233.

On the other hand, upon moving to S30, the master CPU 11 first waits until all the other CPUs 11 complete the third test process of S23. The waiting for it is performed until the judgment is made that the number of waiting target CPUs stored in the register 31 is identical with the waiting count value of the valid subset. When they are identical with each other, the judgment in S31 becomes Yes and the process moves to S32, where the mater CPU 11 collets the respective test results of all the CPUs 11 including own CPU 11, and outputs them on the display 16 via the bus 18 and the output apparatus interface 17 (S32). After that, according to an instruction from the tester via the input apparatus 14, the series of processes in S30 is terminated. S31 is realized by the completion monitoring unit 232, and S32 is realized by the test result output unit 231.

Before explaining S20 in FIG. 5, the first through third test processes which are executed as S21 through S23 in S20 are explained in detail.

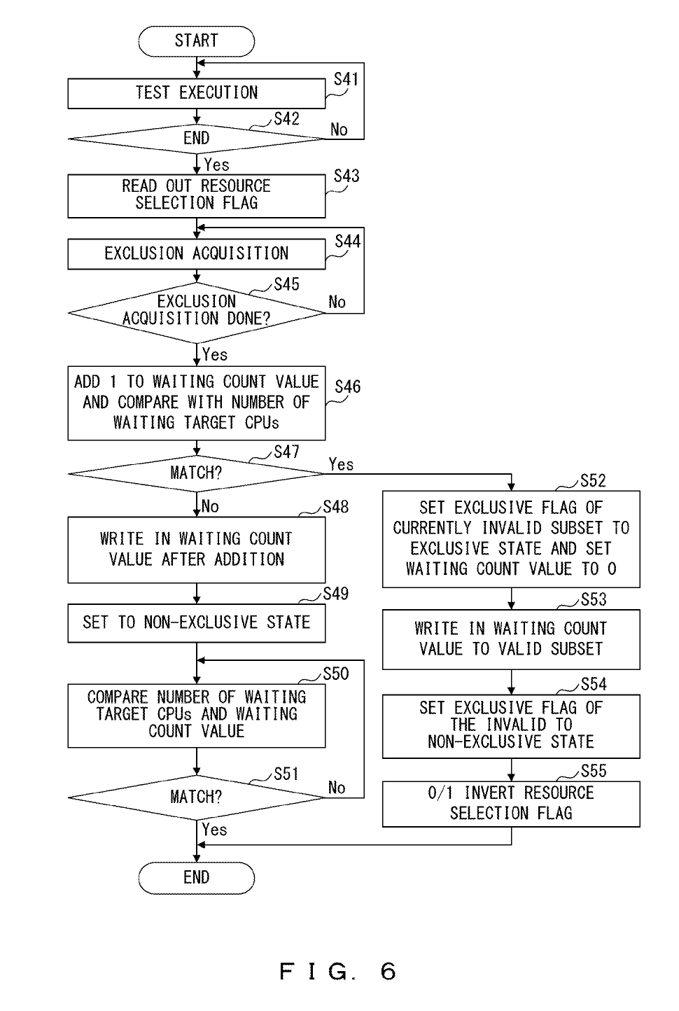

FIG. 6 is a flowchart of the first test process. First, referring to FIG. 6, the first test process executed as S20 is explained in detail. Since the detail of the process executed in S20 is the same in all the CPUs 11, the execution target is described as the “CPU 11” here.

First, the CPU 11 executes the test targeted for the test that should be executed next (S41). Next, the CPU 11 judges whether or not the test is finished (S42). When the test is finished regardless of whether normally or not, the judgment in S42 becomes Yes, and the process moves to S43. When the test has not been finished, the judgment in S42 becomes No, the CPU 11 waits for the test to be finished.

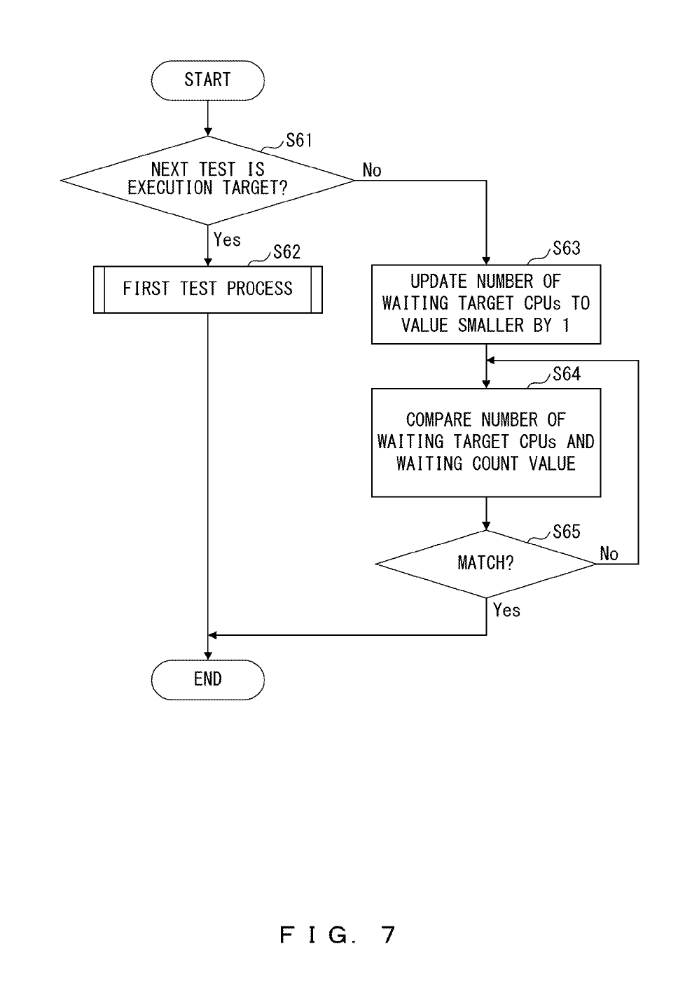

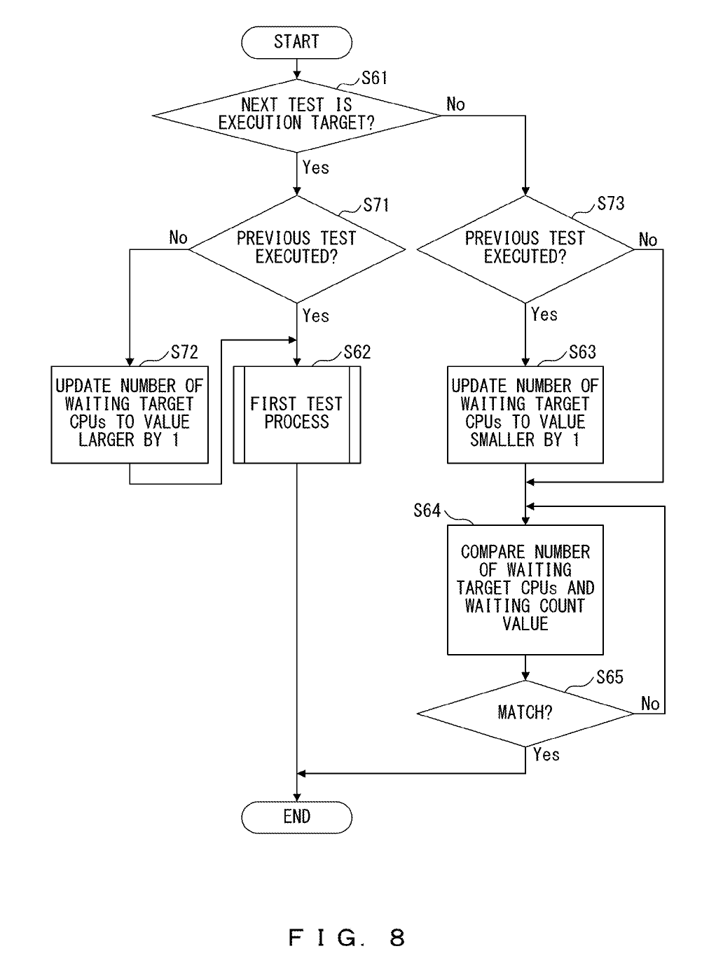

As illustrated in FIG. 7 and FIG. 8, the first test process is also executed in the second test process and the third test process. However, the function of the test unit 22 to realize the process for test execution in S41 is different for the first test process executed as S21, the first test process executed during the second test process in FIG. 22, and the first test process executed during the third test process in S23. In the first test process executed as S21, the first test by the first test execution unit 221a is performed. In the first tests process executed during the second test process in S22, the second test by the second test execution unit 221b is performed, and in the first test process executed during the third test process in S23, the third test by the third test execution unit 221c is performed. Accordingly, in the first through third test processes, a test for different examination targets is executed. The execution management unit 222 of the test unit 22 realizes the execution of the tests of different examination targets in the first through third test processes.

The tests of different examination targets are executed in synchronization. Accordingly, the first through third test processes are made to be synchronous processes for making the respective CPUs 11 synchronously execute the tests of the same detail.

The process for the test execution has a possibility of an occurrence of a hang-up and the like. When such a hang-up occurs, the exception processing unit 225 regards the occurrence of the hang-up as the end of the process, and sends a notification to the execution management unit 222. Accordingly, S42 is realized by the execution management unit 222 and the exception processing unit 225.

In S43, the CPU 11 reads a test selection flag from the register 32 in the synchronization management area 12a to check the valid subset. Next, the CPU 11 performs exclusion acquisition of the valid subset (S44), and judges whether or not the exclusion acquisition has actually been done (S45). When the value of the exclusive flag of the valid subset is 0, the CPU 11 performs the exclusion acquisition by updating the value of the exclusive flag from 0 to 1. Accordingly, the judgment in S44 becomes Yes and the process proceeds to S46.

On the other hand, when the value of the exclusive flag is 1, the CPU 11 is unable to perform the exclusion acquisition. Accordingly, the judgment in S45 becomes No and the process returns to the above-mentioned S44, where the CPU tries the exclusion acquisition again.

In S46, the CPU 11 reads the waiting count value of the valid subset, increments the read waiting count value, and compares the waiting count value after the increment with the number of waiting target CPUs. Next, the CPU 11 judges whether or not they are identical with each other as a result of the comparison. When they are identical with each other, the judgment in S47 becomes Yes and the process moves to S52. When they are not identical, the judgment becomes No and the process moves to S48.

The move to S48 means that it can be recognized that there is a CPU 11 that is executing S41 in the other CPUs 11. Accordingly, in S48 through S51, a process to wait until all the CPUs 11 that execute S11 finish S41 is performed.

First, in S48, the CPU 11 writes the waiting count value after the increment into the valid subset. Next, the CPU 11 sets the valid subset to the non-exclusive state by updating the value of the exclusive flag from 1 to 0 (S49).

After that, without performing the exclusion acquisition, the CPU 11 reads the waiting count value from the valid subset, and compares the read waiting count value with the number of waiting target CPUs (S50), and judges whether or not they are identical with each other as a result of the comparison (S51).

When they are identical with each other, the judgment in S51 becomes Yes. The judgment of Yes here means that all the CPUs 11 that execute S41 have updated the waiting count value of the valid subset. Accordingly, the first test process ends as the waiting is completed, that is, the synchronization point is detected.

On the other hand, when they are not identical, the judgment in S51 becomes No, and the process returns to the above-mentioned S50, where reading the waiting count value from the valid subset and comparing the read waiting count value with the number of waiting target CPUs are performed again. By doing so, waiting until all the CPUs that execute S41 update the waiting count value of the valid subset is performed.

The judgment of Yes in S47 above means that it updates the waiting count value of the valid subset lastly. Accordingly, in and after S52 being the movement destination after the judgment of Yes in S47, a process to move to the next synchronous process (here, the second test process in S22) is performed.

First, in S52, the CPU 11 sets the value “1” representing the exclusive state to exclusive flag of the currently invalid subset, and write “0” as the waiting count value of the subset. Next, the CPU 11 writes the waiting count value after the increment, into the valid subset (S53). After that, the CPU 11 updates the exclusive flag of the invalid subset to the value “0” representing the non-exclusive state (S54), and performs 0/1 inversion of the value of the resource selection flag (S55). The inversion is performed by updating 0 to 1 in the case in which the previous value is 0, and updating 1 to 0 in the case in which the previous value is 1. After the switching of the valid subset is performed in that way, the first test process ends.

In the first test executed in S21, since the first test is the target, all the CPUs 11 that execute the first test process update the waiting count value of the valid subset. However, in the first test process during the second test process executed in S22, the target is the second test, and not all the CPUs 11 necessarily execute the test. The CPU 11 that does not execute the test has to wait until all the CPUs 11 that execute the test end the test, without updating the waiting count value of the valid subset. S52 is a process for enabling such a CPU 11 that does not execute the test to appropriately perform the waiting. The two subsets are prepared for this reason.

The above-mentioned S43 through S45, S48, S49, and S52 through S55 are realized by the update unit 224 of the test unit 22. S47, S50 and S51 are realized by the synchronization judgment unit 223. S46 is realized by the update unit 224 and the synchronization judgment unit 223.

FIG. 7 is a flowchart of the second test process. Next, referring to FIG. 7, the second test process is explained in detail.

First, the CPU 11 judges whether or not the next test (here, the second test) is the execution target (S61). When an inappropriate portion is found or a problem has been revealed by an occurrence of a hang-up as a result of the execution of S41 during the first test process in S21, that is, the execution of the first test, the judgment in S61 becomes No and the process moves to S63. When such a problem has not been revealed, the judgment in S61 becomes Yes and the process moves to S62.

In S62, the CPU 11 executes the first test process as represented in FIG. 6. Here, a process to execute the second test in S41 is performed. After the first test process ended, the second test process ends.

In S63, the CPU 11 updates the number of waiting target CPUs stored in the register 31 of the synchronization management area 12a to a value that is smaller by one compared with the value up to then. After that, the CPU 11 executes S64 and S65. Since the process detail of S64 and S65 is basically the same as S50 and S51 described above, its explanation is omitted.

FIG. 8 is a flowchart of the third test process. Lastly, referring to FIG. 8, the third test process is explained in detail.

In the second test process described above, the number of waiting target CPUs which is the total number of the CPUs 11 that execute the test is updated only by decreasing it. However, in the third test process, the CPU that executes the third test without executing the second test has to be handled. Accordingly, in the third test process, a process for handling it is added to the second test process. Accordingly, in FIG. 8, the same numeral is assigned to a process of the same or the basically same detail as in the second test process. Here, the explanation is made focusing only on the portions that differ from the second test process.

First, in S61 of the third test, the CPU 11 judges whether or not the next test (here, the third test) is the execution target. When an inappropriate portion is found or a problem has been revealed by an occurrence of a hang-up as a result of the execution of the second test during the second test process in S22, the judgment in S61 becomes No and the process moves to S73. When such a problem has not been revealed, the judgment in S61 becomes Yes and the process moves to S71.

In S71, the CPU 11 judges whether or not the previous test, that is, the second test has been executed. When the second test has been executed, the judgment in S71 becomes Yes, and the first test process in S62, that is, the third test is executed. After that, the third test process ends. When the second test has not been executed, the judgment in S71 becomes No. In that case, the CPU 11 updates the number of waiting target CPUs stored in the register 31 of the synchronization management area 12a to a value larger by 1 compared with the value up to then (S72). After that, the process moves to S62.

Meanwhile, in S73, the CPU 11 judges whether or not the previous test, that is, the second test has been executed. When the second test has been executed, the judgment in S73 becomes Yes. In that case, the CPU 11 moves to S63 to update the number of waiting target CPUs stored in the register 31 of the synchronization management area 12a to a value smaller by 1 compared with the value up to then. When the second test has not been executed, the judgment in S73 becomes No, and the process moves to S64.

In the assumption of the move according to the execution result of the above-mentioned test, judgment in S73 is not No. However, in a different assumption from the assumption, judgment in S73 may be No. When more than three tests are performed, the third test process represented in FIG. 8 may be repeated as a process to execute a test after the third test.

The explanation returns to FIG. 5.

As descried above, in the second test process and the third test process, whether or not to actually execute the execution target test is determined according to the result of the test executed before them, and the number of waiting target CPUs stored in the register 31 of the synchronization management area 12a is updated as needed. The update of the waiting count value is performed only by the CPU 11 that actually executed the test. Thus, the operation of the CPUs 11 differs depending on the CPU 11 according to the situation. In order to explain the difference in operation, FIG. 5 assumes a case in which the CPU 11-2 (described as “CPU2” in FIG. 5) executes the third test without executing the second test according to the result of the first test, and the CPU 11-0 being the master CPU and CPU 11-1 both execute all the tests. The sequence in which the number of waiting target CPUs and the two waiting count values stored in the registers 31, 35 and 36 respectively is represented on that assumption. In order to present the sequence on that assumption, the positions in the vertical direction of the first through the third test processes executed as S21 through S3 in each CPU 11 are made to be different. Accordingly, the positions in the vertical direction of the first through the third test processes represent the timing to access the register 31, 35 or 36.

The first test process in S21 ends in order of the mater CPU 11->CPU 11-1->CPU 11-2 as illustrated in FIG. 5. Accordingly, the waiting count value stored in the register 35 of the valid subset at this time is updated from 0 to 1 by the master CPU 11, and updated from 1 to 2 by CPU 11-1, and updated from 2 to 3 by the CPU 11-2. Since the CPC 11-2 is the last CPU to update the waiting count value, the waiting count value is identical with the number of waiting target CPUs. For that reason, the CPU 11-2 sets the waiting count value of the register 36 of the invalid subset at this time to 0, and updates the resource selection flag from 0 to 1. According to such update, the respective CPUs 11 move to S22.

The CPU 11-2 that moved to S22 does not execute the second test since there is a problem in the first test result. Accordingly, the CPU 11-2 updates the number of waiting target CPUs to 2 from 3 being the value up to then, immediately after moving to S22. The master CPU 11 and the CPU 11-1 that execute the second test end the second test in order of CPU 11-1->the master CPU 11. Accordingly, the waiting count value stored in the register 36 is updated from 0 to 1 by the CPU 11-1, and updated from 1 to 2 by the master CPU 11. Since the master 11 is the last CPU to update the waiting count value, the master 11 also sets the waiting count value in the register 35 of the invalid subset at this time to 0, and updates the resource selection flag from 1 to 0. According to such update, the respective CPUs 11 move to S23.

The CPU 11-2 that moves to S23 executes the third test without executing the second test. For that reason, the CPU 11-2 updates the number of waiting target CPUs to 2 from 3 being the value up to then, immediately after moving to S23. Accordingly, the third test is executed by all the CPUs 11.

The third test ends in order of the CPU 11-1->CPU 11-2->the master CPU 11. Accordingly, the waiting count value stored in the register 35 is updated from 0 to 1 by the CPU 11-1, updated from 1 to 2 by the CPU 11-2, and updated from 2 to 3 by the master CPU 11. By such update, the respective CPUs 11 move from S20 to S30, that is, the control is passed from the test unit 22 to the end processing unit 23. Since the master CPU 11 is the last CPU to update the waiting count value, it also sets the waiting count value in the register 36 of the invalid subset at this time to 0, and updates the resource selection flag from 0 to 1.

Meanwhile, while the waiting count value is updated by increment in the present embodiment, it may also be updated in the subtracting direction. This is because, when, as a result of the subtraction of the waiting count value from the initial value to the end, the waiting count value after the completion of the subtraction is identical with the number of waiting target CPUs, it will do.

In addition, while the respective CPUs 11 are made to autonomously execute the test (the synchronous process) in the present embodiment, the results may be collected from the CPUs that executed the test, and one CPU may be made to select the CPU 11 that should execute the next test. That one CPU may be a CPU that is not the execution target of the test. The one CPU may be made to decide the CPU 11 that executes the test and the number of such CPUs according to the situation, and according to the decision result, the one CPU may make the CPU 11 that should execute the test execute the test.

In this embodiment, the CPU 11 that does not execute the test practically does not perform the valid process until the arrival of the synchronization point (timing at which the match between the waiting count value and the number of waiting target CPUs is confirmed). Accordingly, the CPU 11 that does not execute the test or that does not make something execute the test may be made to execute another process that is required under the situation at that time. Since it is also possible to make any CPU 11 among the CPUs being the execution target of the test (synchronous process) to execute another arbitrary process, a high versatility may be obtained.

While the synchronous process is the process for test execution in the present embodiment, the synchronous process is not limited to such a process. The synchronous process may be any as long as the influence from whether or not it is performed by each CPU (processor) 11 on the execution result of other CPUs 11 is negligible.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus having a storage apparatus shared by a plurality of processors: the information processing apparatus comprising:
a decision unit configured to decide, when there is a process to be executed by the plurality of processors synchronously, a group of processors that execute the process from among the plurality of the processors;
a control unit configured to store a total number of the decided group of processors in the storage apparatus and make the group of processors execute the process;
a counting unit configured to count a number of processor that executed the process among the processors included in the group of processors;
a comparison unit configured to compare the total number of the processors and a counted number of the processors; and
a notification unit configured to send a notification that all the processors included in the group of the processors executed the process, based on a comparison result by the comparison unit.

2. The information processing apparatus according to claim 1, wherein
the control unit is realized by making each processor to be an execution target of the process respectively make a judgment as to whether or not to execute a process that should be executed next and update the total number on the storage apparatus according to a result of the judgment.

3. The information processing apparatus according to claim 2, wherein
when a different value from the total number is stored in the storage apparatus as an initial value of the number of the processors,
the counting unit is realized by making each processor which make a judgment to execute the process that should be executed next update the number of processor after ending the process that should be executed next;
the comparison unit is realized by making each processor to be the execution target respectively compare the number of the processors and the total number on the storage apparatus; and
the notification unit is realized by making each processor that compared the number of processors and the total number on the storage apparatus make a judgment as to whether or not all the processors included in the group of processors executed the process.

4. A synchronous process execution management method for making an information processing apparatus having a storage apparatus shared by a plurality of processors execute a plurality of processes synchronously, the synchronous process execution management method comprising:
making each processor to be an execution target of the process among the plurality of processors make a judgment as to whether or not to execute a process that should be executed next and update a total number of processors that execute a process, the total number being stored in the storage apparatus, according to a result of the judgment;
when shifting to execution of the process that should be executed next, making one of the plurality of processors store an initial value of a count value representing a number of processors that ended a process in the storage apparatus store;
making each processor which make a judgment to execute the process that should be executed next update the count value on the storage apparatus after ending the process that should be executed next; and
making each processor to be the execution target compare the count value and the total value on the storage apparatus and make a judgment as to whether or not all the processors which execute the process that should be executed next ended the process that should be executed next.

5. A computer-readable recording medium having stored therein a program for causing a computer being usable as a processor of a processing system to execute a process comprising:
when there are a plurality of processes to be executed by a plurality of processors synchronously, making a judgment whether or not to execute the processes in units of the process;
updating a total number of processors that execute the processes, stored on a prescribed storage apparatus based on a result of the judgment;
updating a count value representing a number of processors that ended a process, stored in the prescribed storage apparatus after ending the process to be executed according to the judgment; and
referring to the count value and the total number stored on the prescribed storage apparatus and making a judgment as to whether or not all the processor that should execute a process currently being an execution target ended the process being the execution target.
